(19) United States
(12) Patent Application Publication
(10) Pub. No.: US 2026/0124664 A1
(43) Pub. Date: May 7, 2026

(54) HOSE CRIMPING TOOL AND HOLDER COMBINATION

(71) Applicant: Henry C. CHU, Orange, CA (US)

(72) Inventor: Henry C. CHU, Orange, CA (US)

(21) Appl. No.: 18/934,609

(22) Filed: Nov. 1, 2024

(51) Int. Cl. B21D 39/04

(52) U.S. Cl. CPC B21D 39/046

(57) ABSTRACT

A hose crimping tool and holder device includes a holder stand having a base, and two panels extended upwardly from the base for forming a space between the panels, a hand pump set includes a crimper member formed on a hand grip and having a chamber, an arm includes two end portions pivotally attached to two end portions of the crimper member with a pivot axle and a pivot shaft, and a compartment formed in the arm, and a crimper die set engaged with the compartment of the arm and the chamber of the crimper member, and the crimper member is partially engaged with the panels with a pivot pin. The crimper member is engaged between the panels and pivotally mounted to the panels with the pivot pin. A sliding element is slidably engaged in the crimper member and engageable with the crimper die set.

### BACKGROUND OF THE INVENTION

### 1. Field of the Invention

The present invention relates to a hose crimping tool and holder combination, and more particularly to a hand held hydraulic A/C hose crimping tool and holder combination including a special design crimper holder stand for firmly or stably holding or supporting the hose crimping tool in place and for securing and holding the working crimping tool upright throughout the entire crimping process, and for preventing the hose crimping tool from being staggering this way and that.

### 2. Description of the Prior Art

Various kinds of typical hose crimping tools have been developed and provided for crimping rubber hoses, metal tubings/pipings, ferrule/shells (crimping sleeves), and crimping dies etc., and normally

For example, U.S. Pat. No. 5,782,128 to Barjesteh et. al., and U.S. Pat. No. 6,324,884 B1 to Barjesteh et. al. disclose two of the typical hand-held portable crimping tools each comprising a crimper body and a york or arm pivotally or rotatably attached or mounted or secured or coupled to the crimper body for selectively receiving or engaging with one of the selected crimper die sets, and a pump handle pivotally or rotatably attached or mounted or secured or coupled to the crimper body for actuating or operating the selected crimper die set to crimp the selected rubber hose, metal tubing/piping, ferrule/shell (crimping sleeve).

However, the typical hand-held portable crimping tools should always be firmly or stably held or grasped by the user throughout the entire crimping process, and the typical hand-held portable crimping tools may stagger this way and that throughout the entire crimping process, i.e., the typical hand-held portable crimping tools may not be firmly or stably held or supported in place without the user throughout the entire crimping process. In addition, the typical hand-held portable crimping tools have no size checker for checking the correct sizes of the metal tubing/piping, and for checking that the ferrule/crimping sleeve's correct size matches the hose size, or after getting the correct size of the ferrule/crimping sleeve and/or crimping die to match the hose size.

The present invention has arisen to mitigate and/or obviate the afore-described disadvantages of the conventional hose crimping tool and holder combinations.

### SUMMARY OF THE INVENTION

The primary objective of the present invention is to provide a hose crimping tool and holder combination including a special design crimper holder stand for firmly or stably holding or supporting the hose crimping tool in place and for securing and holding the working crimping tool upright throughout the entire crimping process, and for preventing the hose crimping tool from being staggering this way and that.

In accordance with one aspect of the invention, there is provided a hose crimping tool and holder combination comprising a holder stand including a base, and two panels extended upwardly from the base for forming a space between the panels, a hand pump set including a hand grip body, and a crimper body provided on one end of the hand grip body, the crimper body including a chamber formed between a first end portion and a second end portion of the crimper body, an arm including a first end portion pivotally attached to the first end portion of the crimper body with a pivot axle, and a second end portion pivotally coupled to the second end portion of the crimper body with a pivot shaft, and the arm including a compartment formed in the arm and communicating with the chamber of the crimper body, and a crimper die set selectively received and engaged with the compartment of the arm and the chamber of the crimper body, and the crimper body being partially engaged with the panels and pivotally attached to the panels with a pivot pin.

The first end portion of the crimper body is engaged between the panels and pivotally mounted to the panels with the pivot pin.

The hand pump set includes a sliding element slidably received and engaged in the chamber of the crimper body and engageable with the crimper die set.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a hose crimping tool and holder combination in accordance with the present invention;

FIG. 2 is another perspective view illustrating the operation of the hose crimping tool and holder combination;

FIGS. 3, 4 are enlarged partial perspective views illustrating the operation of the hose crimping tool and holder combination;

FIG. 5 is a partial exploded view illustrating the operation of the hose crimping tool and holder combination; and

FIG. 6 is a plan schematic view illustrating a hose, ferrule/shell, crimping die, size checker.

### DETAILED DESCRIPTION OF THE PREFERRED EMBODIMENT

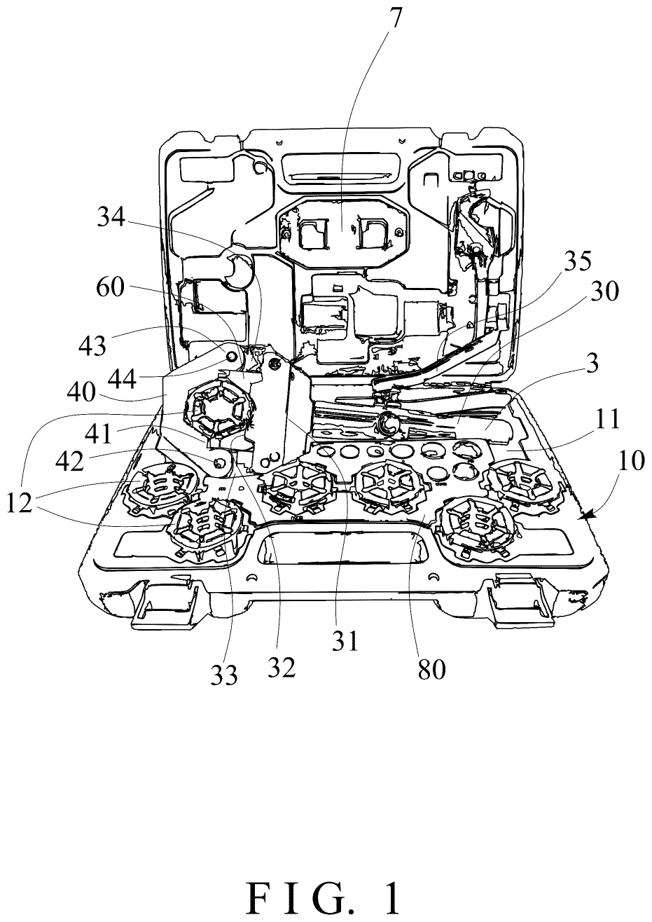

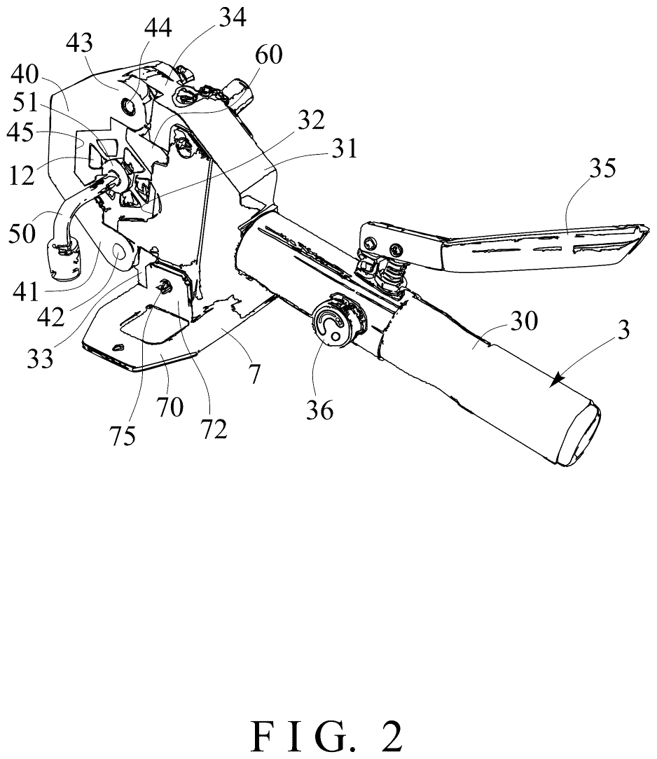

Referring to the drawings, and initially to FIGS. 1 and 2, a hose crimping tool and holder combination in accordance with the present invention comprises a container or plastic protector case or receptacle 10 including a number of cavities or recesses 11 formed therein for receiving various parts or elements therein, such as a hydraulic hand pump set 3, and a number of crimper die sets 12 or the like.

The hydraulic hand pump set 3 includes a shaft or lever or hand grip body 30, and a crimper body 31 formed or provided on one end of the hand grip body 30 or formed integral with the hand grip body 30, and having a compartment or chamber 32 formed therein, such as formed between one or first end portion 33 and another or second end portion 34 of the crimper body 31, for selectively receiving or engaging with one of the selected crimper die sets 12, a york or arm 40 including one or first end portion 41 pivotally or rotatably attached or mounted or secured or coupled to one or first end portion 33 of the crimper body 31 with a pivot axle 42, and another or second end portion 43 pivotally or rotatably attached or mounted or secured or coupled to another or second end portion 34 of the crimper body 31 with a pivot shaft 44, and the arm 40 includes a chamber or compartment 45 formed therein for selectively receiving or engaging with the selected crimper die set 12, for example, the chamber 32 of the crimper body 31 and the compartment 45 of the arm 40 are communicating with each other for receiving or engaging with the selected crimper die set 12 and for selectively receiving or engaging with a selected hose fitting 50, metal tubing/piping, ferrule/shell (crimping sleeve) or the like.

A die or mold or sliding element 60 is slidably received or engaged in the chamber 32 of the crimper body 31 and contactable or engageable with the crimper die set 12 and for actuating or operating the crimper die set 12 to actuate or crimp the hose fitting 50. The hydraulic hand pump set 3 further includes a pump handle 35 pivotally or rotatably attached or mounted or secured or coupled to the hand grip body 30, and connected or coupled to and contacted or engaged with the sliding element 60 for actuating or operating the sliding element 60 toward the crimper die set 12 and for actuating or operating the crimper die set 12 to actuate or crimp the hose fitting 50. The hydraulic hand pump set 3 further includes an ON-OFF hydraulic control valve 36 pivotally or rotatably attached or mounted or secured or coupled to the hand grip body 30 for adjusting the hydraulic forces of the sliding element 60 toward or against the crimper die set 12. The above-described structure or configuration for the coupling or engagement of the pump handle 35 with the sliding element 60 and the structure or configuration of the hydraulic control valve 36 are typical and are not related to the present invention and will not be described in further details.

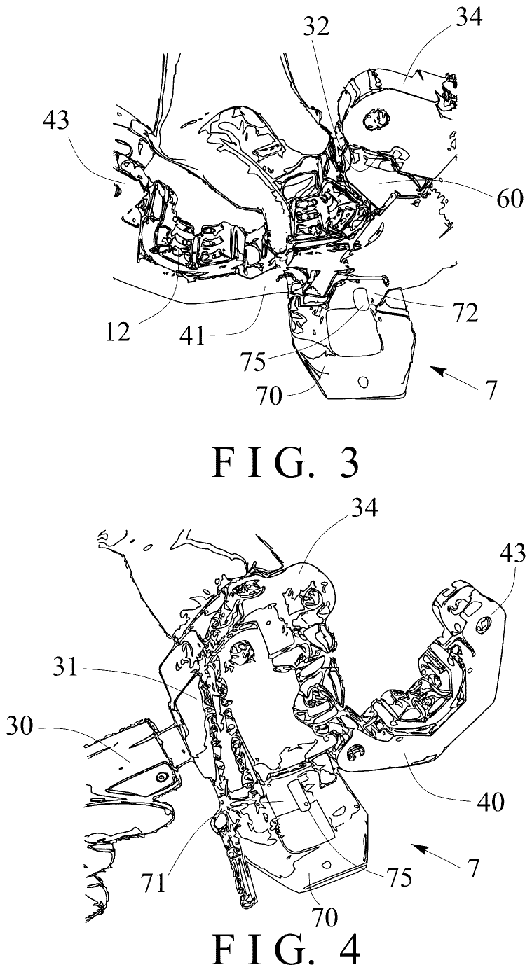

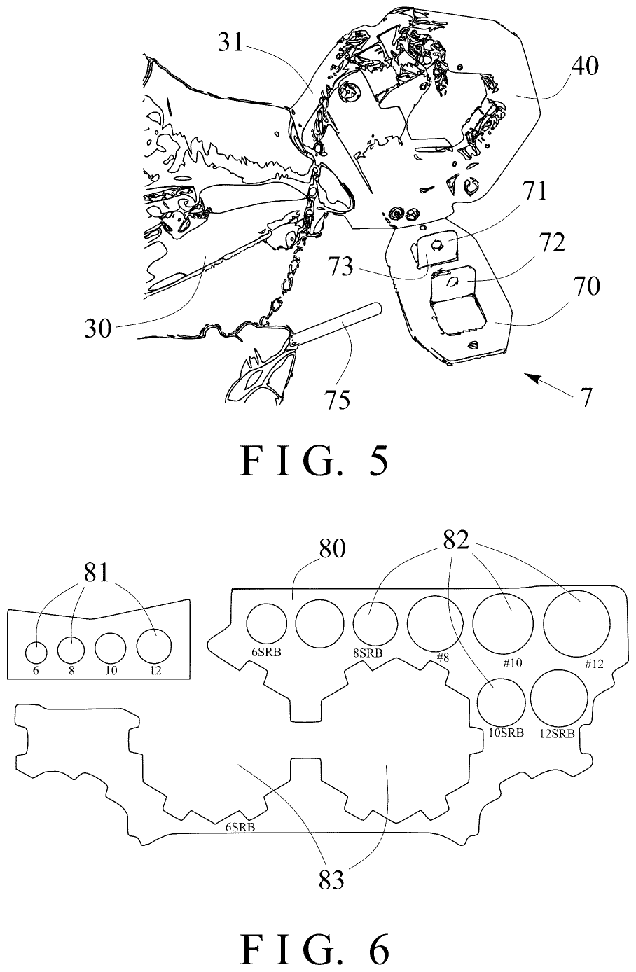

As shown in FIGS. 2-5, the hose crimping tool and holder combination in accordance with the present invention further comprises a special design crimper holder stand 7 including a plate or platform or base 70 for being engaged with or supported on the ground or the supporting surface, and including two flaps or panels 71, 72 extended upwardly from the base 70 for forming or defining a chamber or space 73 in or between the panels 71, 72 and for partially receiving or engaging with the crimper body 31, such as the first end portion 33 of the crimper body 31, and the crimper body 31 may be pivotally or rotatably attached or mounted or secured or coupled to the base 70 or to the panels 71, 72 of the crimper holder stand 7 with a pivot pin 75 for firmly or stably holding or supporting the hydraulic hand pump set 3 in place and for securing and holding the hydraulic hand pump set 3 upright throughout the entire crimping process, and for preventing the hydraulic hand pump set 3 from being staggering this way and that.

As shown in FIGS. 1 and 6, the hose crimping tool and holder combination in accordance with the present invention further comprises a hose, ferrule/shell, crimping die, size checker 80 for selecting or choosing the correct size of ferrule/shell 50 and crimping die 12 for the correct job, for example, the size checker 80 includes a number of holes 81 formed therein for checking or selecting the correct sizes of the metal tubing/piping 51 (FIG. 2), and a number of orifices 82 formed therein for checking or selecting the correct sizes of the ferrule/crimping sleeve/hose fitting 50, and one or more apertures 83 formed therein for checking or selecting the correct sizes of the crimping die 12, such that the size checker 80 may be used for checking the correct sizes of the metal tubing/piping, checking that the ferrule/crimping sleeve's correct size matches the hose size, or after getting the correct size of the ferrule/crimping sleeve to match the hose size, and then you may need to find the proper number of the crimping die 12.

As shown in FIG. 2, the crimper holder stand 7 may thus firmly or stably hold or support the hydraulic hand pump set 3 in place for securing and holding the hydraulic hand pump set 3 upright throughout the entire crimping process, and for preventing the hydraulic hand pump set 3 from being staggering this way and that.

Accordingly, the hose crimping tool and holder combination in accordance with the present invention includes a special design crimper holder stand for firmly or stably holding or supporting the hose crimping tool in place and for securing and holding the working crimping tool upright throughout the entire crimping process, and for preventing the hose crimping tool from being staggering this way and that.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hose crimping tool and holder combination comprising:
a holder stand including a base, and two panels extended upwardly from said base for forming a space between said panels,
a hand pump set including a hand grip body, and a crimper body provided on one end of said hand grip body, said crimper body including a chamber formed between a first end portion and a second end portion of said crimper body, an arm including a first end portion pivotally attached to said first end portion of said crimper body with a pivot axle, and a second end portion pivotally coupled to said second end portion of said crimper body with a pivot shaft, and said arm including a compartment formed in said arm and communicating with said chamber of said crimper body, and
a crimper die set selectively received and engaged with said compartment of said arm and said chamber of said crimper body, and
said crimper body being partially engaged with said panels and pivotally attached to said panels with a pivot pin.

2. The hose crimping tool and holder combination as claimed in claim 1, wherein said first end portion of said crimper body is engaged between said panels and pivotally mounted to said panels with said pivot pin.

3. The hose crimping tool and holder combination as claimed in claim 1, wherein said hand pump set includes a sliding element slidably received and engaged in said chamber of said crimper body and engageable with said crimper die set.

4. The hose crimping tool and holder combination as claimed in claim 1 further comprising a size checker including a plurality of holes formed in said size checker.

5. The hose crimping tool and holder combination as claimed in claim 4, wherein said size checker includes a plurality of orifices formed in said size checker.

6. The hose crimping tool and holder combination as claimed in claim 4, wherein said size checker includes at least one aperture formed in said size checker.
